(19) United States
(12) Patent Application Publication
(10) Pub. No.: US 2004/0237488 A1
(43) Pub. Date: Dec. 2, 2004

(54) Filter assembly with spin-on filters, and methods

(76) Inventor: Eivind Stenersen, River Falls, WI (US)

Correspondence Address: Merchant & Gould P.C., P.O. Box 2903, Minneapolis, MN, 55402-0903, US

(21) Appl. No.: 10/766,999

(22) Filed: Jan. 28, 2004

Related U.S. Application Data
(60) Provisional application No. 60/443,301, filed on Jan. 28, 2003.

(51) Int. Cl. B01D 46/00

(52) U.S. Cl. 55/482

(57) ABSTRACT

A filter assembly including a filter head and two filter elements operably connected in parallel to the filter head for filtering fluid such as natural gas and other fuel gases. The filter assembly includes a filtering material for removal of sulfur compounds from the fluid being filtered; a first filtering material can be used for the removal of mercaptans and a second filtering material can be used for the removal of other sulfur compounds. The filter assembly includes various seals to inhibit leaking of liquid, specifically filtered liquid, from the connection of the filter elements to the filter head. The filter assembly is particularly useful for use in fuel cell systems.

This application claims priority under 35 U.S.C. § 119(e) to U.S. provisional application Ser. No. 60/443,301, filed Jan. 28, 2003 and entitled “Filter Arrangement and Methods”. The entire disclosure of 60/443,301 is incorporated herein by reference.

### FIELD OF THE INVENTION

This disclosure concerns generally a filter assembly for removing contaminants from a fluid, the filter assembly constructed to inhibit leakage of filtered fluid from the filter assembly; any leakage occurring would be of unfiltered fluid. Such a fluid filter assembly is particularly useful for filtering fuel for a fuel cell and fuel cell systems.

### BACKGROUND

In its natural state, natural gas is an odorless and colorless gas; with such properties, it is very difficult to detect a leak in equipment operating on or with natural gas. As a precaution, the natural gas that is available for use includes an odorous additive, typically a sulfur compound such as a mecaptan or thiol. This odor causing additive increases the safeness of working with natural gas. Natural gas and other fuel gases, such as diesel, also include naturally occurring odiferous sulfur compounds.

Filters have been used in a variety of applications and various models and variations of filters have been known over the years. Each design is intended to improve on an aspect of the previous. Some filter assemblies include a cylindrical filter element within a can or housing with a baffle or attachment plate at one end to connect the filter to a filter head, typically by a threaded joint. A central opening and several surrounding openings in the baffle direct flow through the filter and, in particular, through the filter element within the housing. The flow can be in either an inside/out or outside/in pattern. A circular gasket on the outside of the baffle serves as an external seal between the filter and filter head, while another circular gasket on the inside of the cover functions as the internal seal between the filter element and baffle.

Continued improvements in filters are desired.

### SUMMARY

The present invention is directed to a fluid filter and filter assembly that removes undesired chemical components, either naturally occurring components or added components, from a fluid stream. The filter assembly includes various seals that inhibit, and preferably eliminate, leakage of fluid from the filter and the filter assembly to regions external of the filter and filter assembly. The filter and filter assembly especially inhibit the leakage of the fluid that has been filtered.

As discussed above, sulfur compounds such as a mecaptan (thiol) are added to natural gas to increase the safeness of natural gas. Unfortunately, for some uses, the presence of any sulfur component is undesirable. The filter and filter assembly of the present invention is particularly useful in removing sulfur components, both naturally occurring and added, from natural gas and other fuel gases.

The filter of the present invention includes a housing and a filter element contained within the housing. The filter is attached to an appropriate filter head having inlet and outlet ports to provide dirty fluid to the filter and remove clean fluid. The filter and filter head together provide a filter assembly.

The filter assembly is suitable for use in a fuel cell system, which includes a fuel cell, a source of natural gas for the anode side of the fuel cell, and the filter assembly configured for filtering the natural gas prior to the gas reaching the fuel cell. The filter assembly is also suitable for systems utilizing a fuel reformer; a fuel reformer may be positioned upstream of a fuel cell to convert hydrocarbon or alcohol fuels into hydrogen, which is then fed to and used by the fuel cell.

The filter assembly is also suitable for use with internal combustion engines with emission control devices or any other systems utilizing catalysts that can be degraded by contaminants, particularly sulfur.

### BRIEF DESCRIPTION OF DRAWINGS

A better understanding of aspects of the disclosure can be had by reference to the following Detailed Description in conjunction with the accompanying Drawings, wherein:

FIG. 1 is a perspective view of a dual-filter assembly secured to a filter head, one of the filters being shown in cross-sectional view;

FIG. 2. is a top view of one the filters of FIG. 1;

FIG. 3 is a cross-sectional view of the filter taken along line 3-3 of FIG. 2;

FIG. 4 is an enlarged cross-sectional view of a portion of the filter of FIG. 3;

FIG. 5a is a schematic diagram illustrating equipment, including a filter assembly according to the present invention, in a first configuration;

FIG. 5b is a schematic diagram illustrating the equipment of FIG. 1 in a second configuration;

FIG. 5c is a schematic diagram illustrating the equipment of FIG. 1 in a third configuration;

FIG. 5d is a schematic diagram illustrating the equipment of FIG. 1 in a fourth configuration;

FIG. 5e is a schematic diagram illustrating the equipment of FIG. 1 in a fifth configuration;

FIG. 5f is a schematic diagram illustrating the equipment of FIG. 1 in a sixth configuration; and

FIG. 6 is a schematic diagram of a fuel cell system incorporating the filter assembly of the present invention.

### DETAILED DESCRIPTION

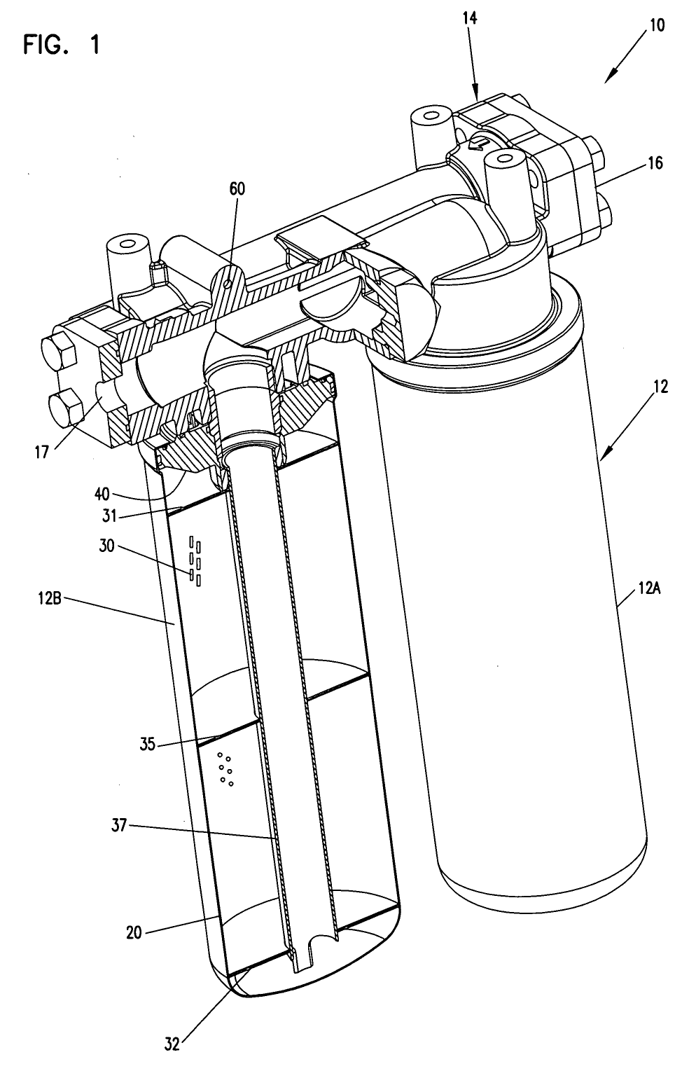

Referring now to the Drawings, wherein like reference numerals denote corresponding elements throughout the views, and particularly referring to FIG. 1, there is shown a fluid filter assembly 10. Filter assembly 10 is particularly adapted for filtration of organic containing fluid, such as natural gas.

Filter assembly 10 includes an assembled filter 12; in the particular embodiment illustrated in FIG. 1, filter assembly 10 includes two filters 12, particularly filter 12A and filter 12B. Filter 12A is illustrated in a perspective view, whereas filter 12B is illustrated in a cross-sectional view, with the internal features of filter 12B visible.

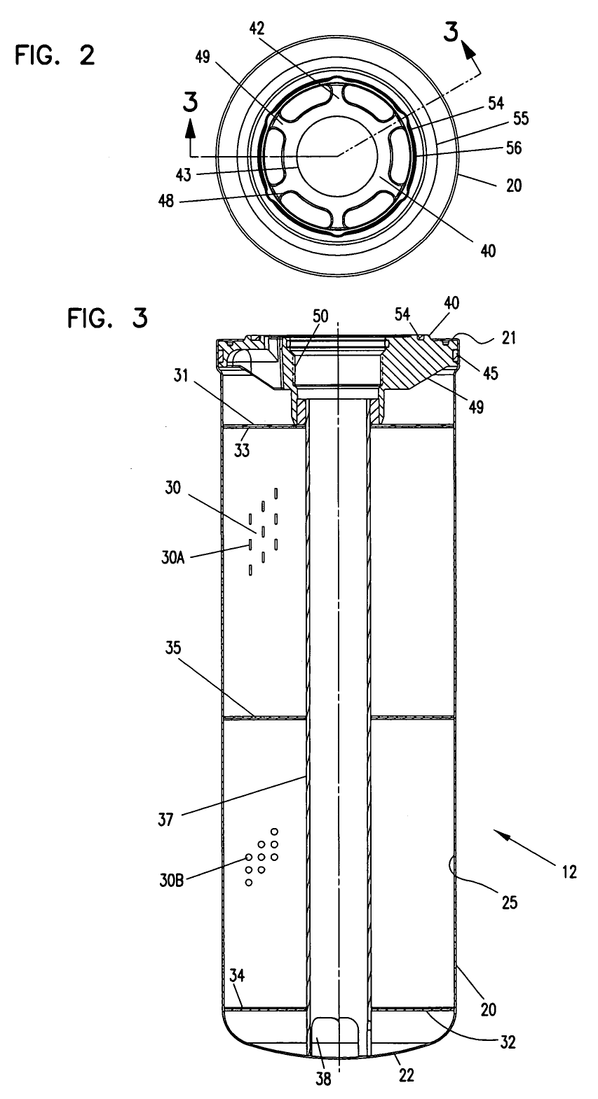

Each of filters 12A, 12B is attached to filter block or head 14 by screwing filter 12A, 12B onto filter head 14 by internal threads on filter 12A, 12B. Specific details regarding filters 12A, 12B will be discussed below in respect to FIGS. 2-4.

Filter assembly 10 includes a supply inlet 16 in head 14 for supplying dirty fluid to filters 12A, 12B. The fluid enters head 14 where the fluid is divided and is filtered either by filter 12A or by filter 12B. The clean fluid exits filter head 14 at outlet 17. Filter head 14 includes various other features, which are described below.

Referring now to FIGS. 1-4, specific details of filter assembly 10 and filters 12A, 12B are described. In FIGS. 2-4, a generic filter 12 is shown, which is indicative of both filter 12A and filter 12B.

The overall shape and size of filter 12 is provided by filter housing 20. Housing 20 generally has an open first end 21 and a closed second end 22. Preferably, housing 20 is of generally thin-walled construction having sufficient integrity to withstand the pressure experienced during typical filtering operations. Housing 20 is typically metal, plastic, or other suitable material. If housing 20 is metal, it is typically formed by stamping or drawing from a metal sheet. A portion of housing 20 may be transparent, to allow visual contact with the inside of filter 12. In preferred applications, housing 20 is generally at least about 15.2 cm (6 inches) long; generally housing 20 is no greater than 61 cm (24 inches) long. Preferably, the length of housing 20 is about 30.5 cm (12 inches) to about 50.8 cm (20 inches), with a diameter of no less than about 7.6 cm (3 inches) and no greater than about 30.5 cm (12 inches), preferably about 10.2 cm (4 inches) to 15.2 cm (6 inches). In one example, housing 20 can be about 36.2 cm (14.3 inches) long, 11.4 cm (4.5 inches) in diameter with a lip forming a diameter of about 12.0 cm (4.7 inches).

Filter housing 20 defines an interior volume 25 in which is retained a filtering material 30. Filtering material 30 removes chemical contaminants from the fluid being filtered, either by adsorption or absorption, or a combination thereof. Filtering material 30 is typically a particulate media, comprising a material such as carbon (generally, activated carbon), alumina (generally, activated alumina), ion exchange resin, zeolites, getters, clays, silica gels, superacids and/or heteropolyacids, strong oxidizers, and metal oxides. The particulate media may have a surface coating thereon or be impregnated or otherwise treated with a material that improves the removal properties of filtering material 30. Filtering material 30 may comprise an inert carrier or base particle, into or onto which is a reactive material that adsorbs or absorbs the desired chemical contaminant. Filter material 30 may include a visual or color indicator so that material 30 changes colors as contaminants are adsorbed or absorbed thereon. The consumer would know to change filter material 30 when the color change has reached a specified point. For example, a yellow material 30 could turn blue as contaminants are collected. For embodiments using such visual indicators, at least a portion of housing 20 should be transparent to allow viewing of the changing color.

A combination of multiple filtering materials 30 may be used, for example, to provide a broader spectrum of compounds removed. Multiple filtering materials 30 may be intermingled or may be present in separate portions, such as in series within housing 20. See FIG. 3, where filtering material 30 is provided as a first filtering material 30A and a second filtering material 30B. If two different filtering materials 30 are used, materials 30A, 30B may be present as a 50/50 ratio, 75/25, or other ratio, the ratio being either by volume or weight.

A preferred filtering material 30 for removing mercaptan compounds (thiols) from natural gas is “CNG1” from Engelhard Corp. of New Jersey. A preferred filtering material 30 for removing other sulfur compounds from natural gas is “CNG2” from Engelhard. The mercaptan compounds can be removed before or after other sulfur compounds are removed. In a preferred embodiment, first filter material 30A (preferably “CNG1”) removes mercaptan compounds from the natural gas stream and then second filter material 30B (preferably “CNG2”) removes other sulfur compounds.

The total filtering material 30, that is filtering materials 30A and 30B, occupies at least 50% of interior volume 25, preferably at least 70%. In one example, filtering material 30 fills at least 80% of interior volume 25. In the embodiment illustrated in FIGS. 1 and 3, materials 30A and 30B are present at generally equal amounts and together occupy about 85% of interior volume 25. Filtering material 30 should be positioned within housing 20 so that the fluid passing through filter 12 comes into contact with filtering material 30 for at least a minimal period of time. This minimal period of time should be the minimum residence time needed for the contaminants to be adsorbed, absorbed, or otherwise retained or removed by filtering material 30. Care should be taken to minimize channels within filtering material 30. That is, filtering materials 30 should be packed within volume 25 tightly to provide minimal void space and even distribution of material 30.

Filter 12 may include any number of screens, plates, sieves or other perforated members arranged within housing 20 to contain and keep filtering material 30 retained and preferably tightly packed. In FIG. 3, filter element 12 includes a first screen 31 proximate first end 21 of housing 20, a second screen 32 proximate second end 22 of housing 20, and a third screen 35, positioned close to the center of the length of housing 20. Screens 31, 32, 35 hold or retain filtering material 30 tightly packaged and inhibit movement of filtering material 30 throughout interior 25. In addition, center screen 35 can be used to separate two different types of filtering material 30. In the embodiment illustrated, center screen 35 separates first material 30A from second material 30B.

Each of screens 31, 32, 35 forms a tight fit between tube 37 and housing 20. Preferably, second screen 32, positioned proximate second end 22 of housing 20, is attached to tube 37, for example, by welding. A fixed second screen 32 provides a stable base for filtering material 30 within housing 20. Screens 31 and 35 may or may not be fixed in or to tube 37. Screens 31, 32, 35 support tube 37 centrally within housing 20. See FIG. 1, where filter 12B is illustrated cut open, with screens 31, 32, 35 supporting tube 37.

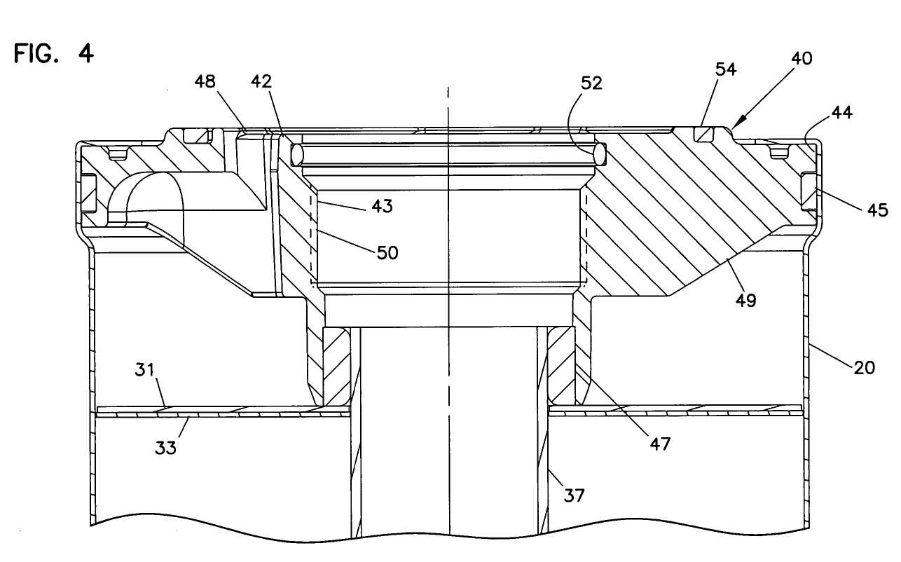

A porous membrane or other filter media can be provided adjacent screens 31, 32 to retain any small particles or dust from filtering material 30 within the desired volume. In the illustrated embodiment, seen in FIGS. 3 and 4, a first membrane 33 is positioned between first screen 31 and filtering material 30, and a second membrane 34 is positioned between second screen 32 and filtering material 30. A membrane may or may not be positioned at center screen 35. Membranes 33, 34 should be constructed to allow fluid to pass therethrough with minimal pressure drop but to retain small particles of filtering material 30 and to capture any contaminant particles that may in the fluid stream. Examples of suitable membranes 33, 34 include cellulosic filter medias, polypropylene material, PTFE, and the like.

Screens 31, 32 and 35 help support hollow tube 37 that extends from first end 21 to second end 22 of housing 20 and through filtering material 30. Preferably, tube 37 abuts or seats against second end 22 of housing 20. Tube 37 is preferably centered within housing 20. Tube 37 forms a passage through filtering materials 30 and includes a plurality of apertures 38 at second end 22. Apertures 38 may be fully defined by central tube 37, or apertures may be defined in part by tube 37 and in part by housing 20. Apertures 38 are preferably positioned between screen 32 and housing second end 22, so that apertures 38 are positioned in an open volume defined by screen 32 and housing second end 22. By having apertures 38 positioned in this open volume, the gas or other material being filtered must pass through the entire length of filtering material 30, that is, from first screen 31 to second screen 32.

Central tube 37 generally has a diameter at least about 0.6 cm (about 0.25 inches); tube 37 generally has a diameter no greater than about 7.5 cm (about 3 inches). Tube 37 has a diameter that, as a ratio with respect to the diameter of housing 20, is about 1:18 to 1:1.5. In one example, central tube 37 can be about 32.8 cm (12.9 inches) long and 1.18 cm (1.26 inches) in diameter. Central tube 37 is typically metal, plastic, or other suitable material. The passage created by central tube 37 extends from housing second end 22, or close thereto, to filter head 14.

Screens 31, 32, 35 can be welded or otherwise attached to central tube 37 in order to stabilize and support tube 37. Additionally or alternatively, central tube 37 can be welded or otherwise attached to housing second end 22 in order to support tube 37.

Filter 12 includes a baffle plate 40, which is positioned at housing first end 21 adjacent to filter head 14 when filter 12 is mounted on filter head 14 (FIG. 1). Baffle plate 40 includes a hub 42 that defines a central fluid port 43 extending through baffle plate 40, preferably along a central axis. Baffle plate 40 also includes a plurality of apertures 48 circumferentially spaced around port 43 and extending through baffle plate 40. Apertures 48 are not in fluid communication with port 43; that is, apertures 48 form passages through hub 42 exclusive from port 43.

Central fluid port 43 provides fluid communication between filter head 14 and central tube 37. Fluid port 43 and central tube 37 are shaped and sized to have port 43 and tube 37 join. In the embodiment illustrated, central tube 37 seats radially within port 43 and forms a leak-free seal with hub 42. A gasket or other seal 47 can be provided to inhibit leaking between baffle plate 40 and central tube 37.

As mentioned, baffle plate 40 also includes apertures 48 which allow passage of fluid through baffle plate 40. Apertures 48 are separated by ribs 49 and hub 42 preferably extends below ribs 49. Apertures 48 provide fluid communication between interior volume 25 and filter head 14.

The upper internal surface of central fluid port 43 includes threads 50 for connecting filter 12 to filter head 14. Filter head 14 includes a set of corresponding threads for accepting threads 50 of filter 12. Filter 12 is commonly referred to as a “spin-on filter”. In the embodiment illustrated, filter 12 is often referred to as “female threaded” or the like, and filter head 14 is often referred to as “male threaded” or the like.

For additional details regarding the general structure of hub 42, port 43, apertures 48, ribs 49, threads 50, and other features of baffle plate 40, see U.S. Pat. No. 4,369,113 (Stifelman) and U.S. Pat. No. 4,743,374 (Stifelman), the disclosures of which are incorporated herein by reference. Additionally, these two patents disclose details of a preferred method for attaching and sealing housing 20 to hub 42; this method provides a seam or edge often referred to as a “rolled” or “spun” seam or edge. Another preferred method for attaching and sealing housing 20 to hub 42 is disclosed in U.S. Pat. No. 6,384,369 (Stenersen et al.), which is also incorporated herein by reference. This method provides a seam or edge by laser welding. Both of these two seams or edges (i.e., rolled or spun, and laser welded) are preferred over crimped edges, at least because of the increased strength of the resulting seam.

Although the connection formed between threads 50 and the threads on filter head 14 is generally considered to be leak-free (that, is, no fluid should be able to pass between threads 50 and the threads on filter head 14), a circumventing seal, gasket or o-ring 52, seen best in FIG. 4, is positioned on the inner surface of port 43 between threads 50 and the top of baffle plate 40. Seal 52 provides additional protection against leaks from occurring between fluid port 43 and filter head 14.

Best seen in FIG. 4, baffle plate 40 has a sealing edge 44 that provides a mechanical interlock between baffle plate 40 and housing 20; this mechanical interlock is designed so that no fluid from either interior volume 25 or filter head 14 can pass between housing 20 and baffle plate 40 at sealing edge 44. An additional seal is added at sealing edge 44 by an o-ring or gasket 45 to further inhibit any leakage of material between baffle plate 40 and housing 20. O-ring 45 seals baffle plate 40 to housing 20 providing additional protection against leaks from between housing 20 and baffle plate 40.

Baffle plate 40 can be formed of any suitable material, such as aluminum, iron, or other metal. In some filtration applications, it may be desirable to form baffle plate 40 by molding from plastic, ceramic, or other material. Baffle plate 40 is preferably formed, such as by casting, into a rigid integral unit. In many embodiments, hub 42 is integral with baffle plate 40; that is, the two elements are one structural piece. A rubber gasket or grommet 54 seated in a groove in baffle plate 40 provides a seal between baffle plate 40 and filter head 14; grommet 54 provides a leak-proof seal.

Filter assembly 10 is a construction that inhibits leaks of fluid material therefrom. The collection of various seals, and the path of fluid flow through filter 12 in an “outside-to-in” manner, greatly inhibits the opportunity for filtered material (such as natural gas) having the mercaptan and sulfurs removed therefrom, to leak to a region external to filter assembly 10 without contacting unfiltered material. If any leakage of filtered material were to occur, the filtered material would be mixed with the unfiltered material, and, any subsequent leakage external to filter assembly 10 would include unfiltered material, such retaining the smelly mercaptans and sulfur. Filter assembly 10 increases the safeness of working with natural gas.

Method of Operation and Servicing

As described above, filter assembly 10, which includes the assembled filters 12A, 12B and filter head 14, is placed in a system, such as fuel cell system 100 as shown in FIG. 6: Filters 12A, 12B are attached to filter head 14 by screwing filters 12A, 12B onto filter head 14 by internal threads 50. Thread o-ring seal 52 and grommet seal 54 inhibit leakage between filter elements 12A, 12B and filter head 14.

System 100 includes a supply of natural gas 70 supplied to filter assembly 10 through inlet 16 (see FIG. 1) of filter head 14. The natural gas enters and is filtered by the filters 12A, 12B of filter assembly 10. The clean fluid exits filter assembly 10 via outlet 17 (see FIG. 1) as clean gas 72. Clean gas 72 is used as a fuel source for a fuel cell 110.

In alternative embodiments, system 100 may include a fuel reformer positioned upstream of fuel cell 110 in natural gas supply 70. Filter assembly 10 would be constructed to remove sulfur contaminants from the natural gas before the fuel reached the fuel reformer and fuel cell 110.

Fuel cell 110 is one type of power-producing equipment whose efficiency and operation can be detrimentally affected, even inhibited, by certain types of contaminants present in its fuel source. Fuel cell 110 has an anode and a cathode, and power is generated through a catalytic reaction. One common type of fuel cell is a hydrogen fuel cell, in which a hydrogen fuel source is directed to the anode, and in which an oxygen source is directed to the cathode. The reactions at the anode and cathode free electrons, which travel through an external circuit and provide an electrical current that can be used as a power source for external electrical circuits. The positively charged ions diffuse through the fuel cell electrolyte to the cathode where the ions combine with the electrons and oxygen to form water and carbon dioxide, by-products of the process. Chemical contaminants present in either the hydrogen source or the oxygen source can inhibit the operation of the fuel cell. Similarly, particulate contaminants present in the oxygen source can inhibit the operation of the fuel cell.

Filter 12 is particularly suited for use with two particular types of fuel cells, PEM fuel cells and solid oxide fuel cells. Proton exchange membrane fuel cells (PEM fuel cells) contain a solid polymer electrolyte. Their low temperature operation, high power density with the ability to vary their output quickly to meet shifts in power demand, make their use ideal for both mobile and stationary applications, such as powering vehicles or buildings. Solid oxide fuel cells (SOFCs) use a ceramic electrolyte material and operate at temperatures up to about 1000° C. SOFCs are best suited for large-scale stationary power generators that provide electricity for factories or towns.

An oxygen filtration system 120 may be included on the oxygen source stream prior to the oxygen reaching fuel cell 110. Oxygen filtration system 120 can include at least one particulate filter, at least one chemical filter, or any combination of particulate and chemical filtration. A sound suppression system may also be included, to muffle or attenuate sounds coming from the equipment used to move the oxygen, equipment such as a compressor. Examples of suitable oxygen filtration systems 120 are disclosed in U.S. Pat. No. 6,432,177 (Dallas et al.), U.S. Pat. No. 6,638,339 (Dallas et al.), and in pending U.S. patent applications Ser. No. 09/832,715, filed Apr. 11, 2001; Ser. No. 09/879,441, filed Jun. 12, 2001; Ser. No. 10/122,647, filed Apr. 10, 2002; and Ser. No. 10/241,117, filed Sep. 10, 2002, all of which are incorporated herein by reference.

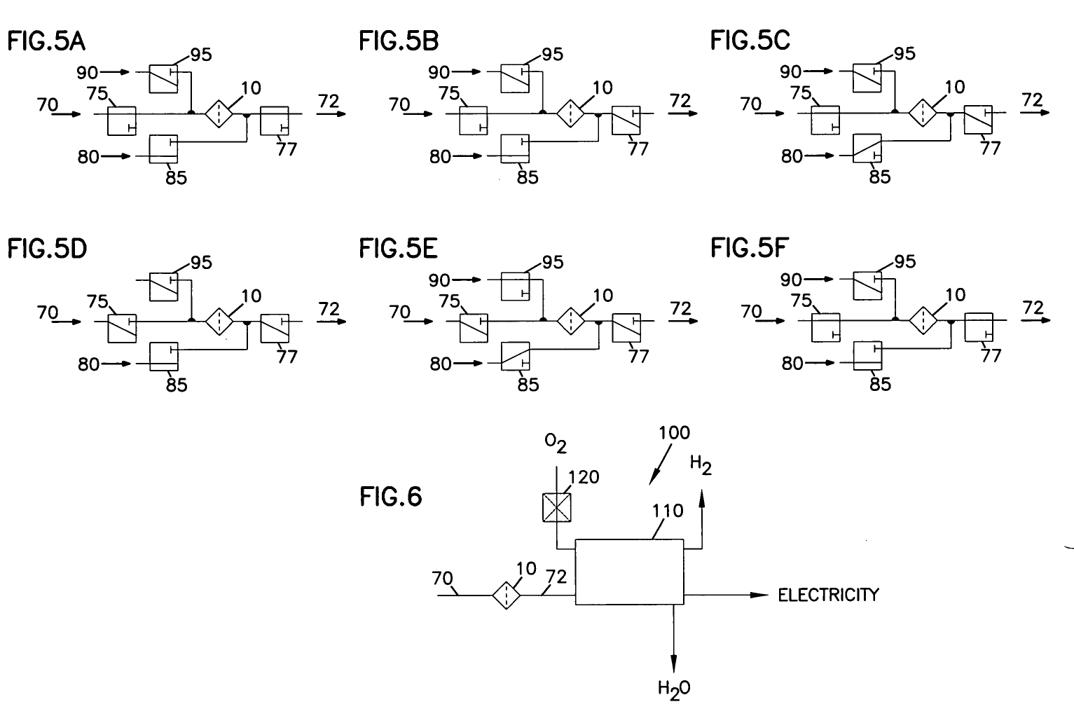

When filter 12 of assembly 10 is dirty or loaded with contaminants collected from natural gas 70, filter 12 is removed and replaced with a new or fresh filter 12. To minimize the release of filtered natural gas 72, which has had the smelly mercaptans and other sulfur additives removed therefrom, a preferred purging sequence is schematically depicted in FIGS. 5A-5F.

Connected to filter assembly 10 are various piping and valves, a natural gas source 70 to which is operably connected a gas valve 75, an inert gas source 80 to which is operably connected a valve 85, an air line 90 having valve 95, and filtered natural gas stream 72 which is operably connected to valve 77. Carbon dioxide and nitrogen are suitable inert gases for use with filter assembly 10 and the below described procedure. As seen in FIGS. 5A-5F, unfiltered natural gas 80 and air line 90 join upstream of filter assembly 10, and inert gas source 80 joins filtered natural gas 72.

Normal filtering operation of natural gas 70 through filter assembly 10 is depicted in FIG. 5A. In this configuration, unfiltered gas 70 flows through open valve 75 to filter assembly 10 and filtered gas 72 flows through open valve 77. Both valves 85, 95 for inert gas 80 and air 90 are closed.

FIGS. 5B-5E step through a process for changing filter 12 of filter assembly 10. First, referring to FIG. 5B, the flow of filtered gas 72 is stopped by closing valve 77 so that no gas 72 flows therethrough. Flow of gas 70 and 72 is stopped due to closed valve 77. Next, valve 85 is opened so that inert gas 80 flows; this flow is backwards through filter assembly 10 so that any remaining filtered gas 72, and preferably unfiltered gas 70, is backflushed out from filter 12 of filter assembly 10. See FIG. 5C. Valve 85 is closed in FIG. 5D, stopping the flow of inert gas 80 and valve 75 is closed, stopping the flow of gas 70 to filter assembly 10. Preferably, valve 75 is closed prior to valve 85 being closed. At this step, all valves 75, 77, 85 and 95 are closed, providing no flow to filter assembly 10. Filter 12 can now be unscrewed from filter head 14 and a second, new filter 12 positioned on filter head 14.

Prior to passing natural gas through the new filter 12, any air should be removed from filter 12; removal of air from filter assembly 10 and the connected lines reduces the opportunity for a fire or explosion which could occur if the oxygen and natural gas mixture is exposed to a flame or spark. Referring to FIG. 5E, both valves 85, 95 are opened. Inert gas 80 flows through open valve 85, backwards through filter assembly 10 and filter 12, and out through open valve 95. The air present in filter assembly 10 and the inert gas 80 are blown through valve 95 and can be released into a holding tank or to the atmosphere.

To return filter assembly 10 to normal filtering operation, valves 85, 95 are closed and then the flow of natural gas 70 to and from filter assembly 10 is resumed by opening valves 75, 77. Filtered natural gas 72 can then be used as a fuel source for fuel cell 110, as described in relation to FIG. 6.

The foregoing description, which has been disclosed by way of the above examples and discussion, addresses embodiments of the present invention encompassing the principles of the present invention. The embodiments may be changed, modified and/or implemented using various types of arrangements. Although the invention has largely been described in terms of filtering natural gas, it is understood that filter 12 and the related systems can be used to remove any sulfur components from any fuel gas, such as natural gas, diesel, gasoline, etc., whether the ‘fuel gas’ is present as a gas or a liquid. Those skilled in the art will readily recognize various modifications and changes which may be made to the present invention without strictly following the exemplary embodiments and applications illustrated and described herein, and without departing from the scope of the present invention which is set forth in the following claims.

What is claimed:

1. A filter assembly for filtering natural gas, the filter assembly comprising:
(a) a filter head having an inlet and an outlet, and a first filter receiving threaded area and a second filter receiving threaded area, the first filter receiving threaded area in parallel flow with the second filter receiving threaded area from inlet to outlet; and
(b) a first filter and a second filter, each of the filters comprising:
(i) a housing having a first open end, an outer periphery at the first end, a second closed end, and an interior;
(ii) a baffle plate sealingly connected to the outer periphery of the housing with a perimeter seal, the baffle plate defining a plurality of inlet apertures and a central outlet fluid port having internal threads constructed to engage with the filter receiving threaded area, a seal present at the internal threads, and a seal circumscribing the plurality of inlet apertures, the baffle plate in fluid communication with the housing interior via the inlet apertures;
(iii) a filtering material present within the housing, the filtering material comprising a first filtering material selected to remove mercaptans from natural gas by adsorption and a second filtering material selected to remove sulfur compounds from natural gas by adsorption; and
(iv) a central tube extending from the central fluid port to the second end of the housing through the filtering material, the central tube having at least one aperture proximate the housing second end and positioned between the housing second end and the filtering material, with no aperture present in the central tube within the filtering material.

2. The filter assembly according to claim 1, wherein the first filtering material is present in a first portion of the housing and the second filtering material is present in a second portion of the housing.

3. The filter assembly according to claim 2, wherein the first filtering material is separated from the second filtering material by a perforated member.

4. The filter assembly according to claim 3 comprising three perforated members: a first perforated member proximate the baffle plate; a second perforated member proximate the housing second end; and a third perforated member separating the first filtering material from the second filtering material.

5. The filter assembly according to claim 4, wherein at least one of the first perforated member, the second perforated member, and the third perforated member is attached to the central tube.

6. The filter assembly according to claim 1, wherein the housing and the baffle plate are joined at a seam formed by laser welding.

7. The filter assembly according to claim 1, wherein the housing and the baffle plate are joined at a seam formed by roll seaming.

8. A method for filtering natural gas; the method comprising:
(a) providing a filter assembly comprising:
(i) a filter head having an inlet and an outlet, a first filter receiving threaded area and a second filter receiving threaded area, the first filter receiving threaded area in parallel flow with the second filter receiving threaded area from inlet to outlet; and
(ii) a first filter and a second filter, each of the filters removably connected to the filter head via the filter receiving threaded areas, the filters each comprising
(A) a housing having a first open end, an outer periphery at the first end, a second closed end, and an interior;
(B) a baffle plate sealingly connected to the outer periphery of the housing with a perimeter seal, the baffle plate defining plurality of inlet apertures and a central outlet fluid port having internal threads constructed to engage with the filter receiving threaded area, a seal present at the internal threads, and a seal circumscribing the plurality of inlet apertures, the baffle plate in fluid communication with the housing interior via the inlet apertures;
(C) a central tube extending from the central fluid port to the second end of the housing, the central connected to the housing second end;
(D) a first filtering material and a second filtering material each present within the housing;
(b) providing unfiltered natural gas to the filter head via the inlet and splitting the unfiltered natural gas into a first stream and a second stream;
(c) passing the first stream through the first filter and passing the second stream through the second filter, the step comprising:
(i) passing the unfiltered natural gas through the plurality of inlet apertures into the first filtering media to remove mercaptans from the unfiltered natural gas and then passing the natural gas through the second filtering media to remove sulfur compounds to provide a filtered gas;
(ii) flowing the filtered gas through the central tube through the central outlet port; and
(d) collecting the filtered gas from the filter head outlet.

9. The method according to claim 8, wherein the step of passing the unfiltered natural gas through the plurality of inlet apertures is done before the step of flowing the filtered gas through the central tube.
